(19) United States
(12) Patent Application Publication
(10) Pub. No.: US 2018/0349102 A1
(43) Pub. Date: Dec. 6, 2018

(54) APPARATUS AND METHOD FOR CONVERTING LARGE-SCALE APPLICATION

(71) Applicant: SAMSUNG SDS CO., LTD., Seoul (KR)

(72) Inventors: Seung-Yong SHIN, Seoul (KR); Jong-Gurl Moon, Seoul (KR); Yu-Hwan KEUM, Seoul (KR); Dong-Moon KIM, Seoul (KR); Dae-Hyuck IM, Seoul (KR)

(73) Assignee: SAMSUNG SDS CO., LTD., Seoul (KR)

(21) Appl. No.: 15/994,516

(22) Filed: May 31, 2018

(30) Foreign Application Priority Data
May 31, 2017 (KR) 10-2017-0067446

(51) Int. Cl. G06F 8/30

(52) U.S. Cl. CPC G06F 8/30

(57) ABSTRACT

An apparatus and method for converting a large-scale application are provided. The method for converting a large-scale application according to an illustrative embodiment of the present invention includes: decomposing an original application package; extracting one or more application executable files from the decomposed original application package; adding a proxy class file comprising one or more modified classes to the decomposed original application package; replacing at least a part of classes imported in the one or more application executable files with the modified classes; and creating a modified application package comprising the application executable files in which the classes are replaced with the modified classes.

### CROSS-REFERENCE TO RELATED APPLICATION(S)

This application claims the benefit under 35 USC § 119(a) of Korean Patent Application No. 10-2017-0067446, filed on May 31, 2017, in the Korean Intellectual Property Office, the entire disclosure of which is incorporated herein by reference for all purposes.

### BACKGROUND

### 1. Field

The following description relates to an application modification technology.

### 2. Description of Related Art

Enterprise mobility management (EMM) is one of the enterprise mobile security solutions that encompass functions of mobile device management (MDM) and mobile application management (MAM). In particular, as the use of mobile terminals has recently become common practice, mobile trends, such as bring your own device (BYOD) which allows individual employees to use their personal terminals for business purpose, and company-issued, personal enabled (COPE) which allows designated terminals provided by a company to be used for business and personal use, are spreading.

However, as the personal terminals are used for both business and personal purposes, concerns about corporate confidentiality are increasing. There is also a growing demand for dynamically controlling enterprise applications, such as e-mail, instant messaging, and in-house systems required for business, in addition to hardware control functions, such as WiFi of a terminal, camera control, GPS control, and communication control.

In order to control enterprise applications in conjunction with EMM, the enterprise applications must be created separately using API provided by EMM. However, in this case, various existing enterprise applications must be re-created based on EMM, resulting in cost and time problems. Therefore, there is a need for a method for effectively converting an application to include additional functions such as EMM, without separately creating an existing enterprise application.

Meanwhile, as the Android platform continues to grow, the size of Android application is increasing accordingly. An Android application (APK) file contains an executable bytecode files in the form of Dalvik Executable (DEX) files. The Dalvik Executable specification limits the total number of methods that can be referenced within a single DEX file to 65,536, which include Android framework methods, library methods, and methods in an added code. In the context of computer science, the term Kilo, K, denotes 1024 (or 2̂10). Because 65,536 is equal to 64×1024, this limit is referred to as the “64K reference limit”. If the number of methods referenced previously by an existing enterprise application is close to 65K (i.e., in the case of a large scale application), when the application is modified to include an additional function, the application may fail to be executed due to the 64K reference limit. Therefore, there is a need for a method for avoiding the 64K reference limit when converting an application.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The disclosed embodiments are intended to provide a technical means for converting an application to additionally include a desired policy and functions in an existing application.

In addition, the disclosed embodiments are intended to provide a technical means for avoiding a reference limit error which may occur when an application is modified.

In one general aspect, there is provided a method performed by a computing device including one or more processors and a memory in which one or more programs executed by the one or more processors are stored, the method comprising: decomposing an original application package; extracting one or more application executable files from the decomposed original application package; adding a proxy class file comprising one or more modified classes to the decomposed original application package; replacing one or more classes among classes imported in the one or more application executable files with corresponding ones of the one or more modified classes; and creating a modified application package comprising the application executable files in which the one or more classes are replaced with the corresponding ones of the one or more modified classes.

The proxy class file may further comprise one or more application programming interfaces (APIs) used in execution of the one or more modified classes and one or more pieces of policy information referenced in the one or more APIs.

Each of the one or more APIs may comprise program executable code for receiving and updating the one or more pieces of policy information from a preset remote server.

The adding of the proxy class file may comprise changing a file name of the proxy class file by referring to file names of the one or more application executable files and filename creation rules of the one or more application executable files.

The method may further comprise, after decomposing the original application package, extracting an information file related to execution of the original application package from the decomposed original application package and changing a package name of the original application package in the information file.

The method may further comprise, after decomposing the original application package, extracting an icon file of the original application package from the decomposed original application package and replacing the icon file with a substitute icon file.

In another general aspect, there is provided a computing device comprising: a memory configured to store one or more programs; and one or more processors configured to execute the one or more programs to: decompose an original application package; extract one or more application executable files from the decomposed original application package; add a proxy class file comprising one or more modified classes to the decomposed original application package; replace one or more classes among classes imported in the one or more application executable files with corresponding ones of the one or more modified classes; and create a modified application package comprising the application executable files in which the one or more classes are replaced with the corresponding ones of the one or more modified classes.

The proxy class file may comprise one or more application programming interfaces (APIs) used in execution of the one or more modified classes and one or more pieces of policy information referenced in the one or more APIs.

Each of the one or more APIs may comprise program executable code for receiving and updating the one or more policy information from a preset remote server.

The adding the proxy class file may comprise changing a file name of the proxy class file by referring to file names of the one or more application executable files and filename creation rules of the one or more application executable files.

The one or more processors may be further configured to execute the one or more programs to, after the decomposing the original application package: extract information file related to execution of the original application file from the decomposed original application package and change a package name of the original application package in the information file.

The one or more processors may be further configured to execute the one or more programs to, after the decomposing the original application package: extract an icon file of the original application package from the decomposed original application package and replace the icon file with a substitute icon file.

In yet another general aspect, there is provided a non-transitory computer readable recording medium having embodied thereon one or more programs, which when executed by one or more processors of a computing device, causes the computing device to execute a method, the method including: decomposing an original application package; extracting one or more application executable files from the decomposed original application package; adding a proxy class file comprising one or more modified classes to the decomposed original application package; replacing one or more classes among classes imported in the one or more application executable files with corresponding ones of the one or more modified classes; and creating a modified application package comprising the application executable files in which the one or more classes are replaced with the corresponding ones of the one or more modified classes.

Other features and aspects will be apparent from the following detailed description, the drawings, and the claims.

### BRIEF DESCRIPTION OF THE DRAWINGS

FIG. 1 is a block diagram for describing a computing environment including a computing device suitable for use in illustrative embodiments.

FIG. 2 is a diagram for describing a file format of an Android application package.

FIG. 3 is a flowchart for describing a method of converting an application according to one embodiment of the present disclosure.

FIG. 4 is a block diagram for describing a proxy class file according to one embodiment of the present disclosure.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art.

Descriptions of well-known functions and constructions may be omitted for increased clarity and conciseness. Also, terms described in below are selected by considering functions in the embodiment and meanings may vary depending on, for example, a user or operator's intentions or customs. Therefore, definitions of the terms should be made on the basis of the overall context. The terminology used in the detailed description is provided only to describe embodiments of the present disclosure and not for purposes of limitation. Unless the context clearly indicates otherwise, the singular forms include the plural forms. It should be understood that the terms “comprises” or “includes” specify some features, numbers, steps, operations, elements, and/or combinations thereof when used herein, but do not preclude the presence or possibility of one or more other features, numbers, steps, operations, elements, and/or combinations thereof in addition to the description.

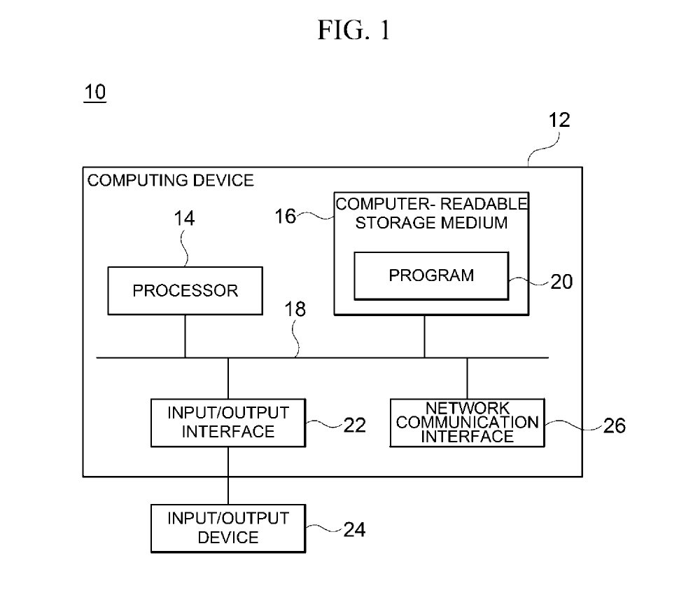

FIG. 1 is a block diagram for describing a computing environment 10 including a computing device suitable for use in illustrative embodiments. In illustrated embodiment, components each may provide different functions and capabilities as well as the functions and capabilities described herein, and extra components may be included in addition to those described below.

The illustrated computing environment 10 includes a computing device 12. In one embodiment, the computing device 12 may be an apparatus for converting an application according to embodiments of the present disclosure. The computing device 12 includes at least one processor 14, a computer-readable storage medium 16, and a communication bus 18. The processor 14 may cause the computing device 12 to operate in accordance with the aforementioned illustrative embodiments. For example, the processor 14 may execute one or more programs 20 stored in the computer-readable storage medium 16. The one or more programs may include one or more computer-executable instructions, which, when executed by the processor 14, cause the computing device 12 to perform operations in accordance with the illustrative embodiments.

The computer-readable storage medium 16 is configured to store computer-executable instructions, program code, program data, and/or other suitable forms of information. The program 20 stored in the computer-readable storage medium 16 includes a set of instructions executable by the processor 14. In one embodiment, the computer-readable storage medium 16 may be memory (volatile memory, such as random access memory (RAM), non-volatile memory, or any suitable combination thereof), one or more magnetic disc storage devices, optical disk storage devices, flash memory devices, and other forms of storage media accessible by the computing device 12 and capable of storing desired information, or any suitable combination thereof.

The communication bus 18 interconnects other components of the computing device 12 including the processor 14 and the computer-readable storage medium 16.

The computing device 12 may include one or more input/output interfaces 22 configured to provide interfaces for one or more input/output devices, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (a mouse, a trackpad, or the like), a keyboard, a touch input device (a touchpad, a touch screen, or the like), a voice or sound input device, an input device, such as a variety of sensor devices and/or an image capturing device, and/or an output device, such as a display device, a printer, a speaker and/or a network card. The exemplary input/output device 24 may be included in the computing device 12 as one component constituting the computing device 12, or may be connected to the computing device 12 as an independent device separate from the computing device 12.

The computing device 12 in accordance with the embodiments of the present disclosure is an apparatus for converting an original application by adding an additional function or policy to the original application. The computing device 12 according to the embodiments of the present invention may decompose an original application package to be modified, extract an application executable file therefrom, add a proxy class file related to an additional function to the application executable file, and then reconstruct the unzipped original application package to create a modified application package. In the embodiments of the present disclosure, the proxy class file may refer to a file consisting of an interface used in the additional function to be added to the application and a set of classes including a class which is imported by a particular class of the original application package. For example, when the additional function is related to enterprise mobility management (EMM), the proxy class file may be composed of an interface used in EMM and a set of classes including a class imported by a particular class of the original application package. In the embodiments of the present disclosure, the proxy class is referred to as a “proxy” class because it is configured to, when a function required for an additional function or an equivalent function is operated at the time of calling an internal logic of an application, pass the function through the class, like a proxy server commonly used in a network.

For example, the computing device 12 in accordance with the embodiments of the present disclosure may be used to add a security function, such as EMM, to an enterprise application developed without considering a security function. In this case, a company or the like can easily create an enterprise application equipped with a security function without newly re-creating the currently used application. However, the embodiments of the present disclosure are not limited to a specific use, such as the security described above, and may be applicable without limitation in applying various additional functions or policies to the original application.

In the embodiments of the present disclosure, an application package is one of application distribution forms and is configured to include executable code and additional data (execution environment, additional content, etc.) required for executing the application. In the following description, the embodiments of the present disclosure will be described based on a format (APK file format) of Android application package published by Google Inc. for convenience of description. However, it should be noted that the embodiments of the present disclosure are not limited to a specific type of file format.

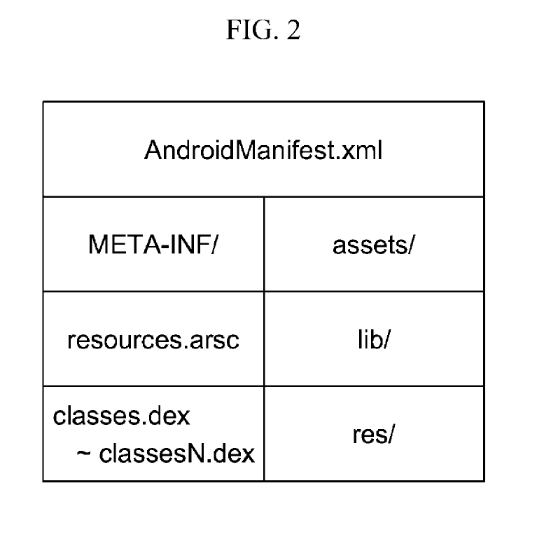

FIG. 2 is a diagram for describing a file format of an Android application package. An Android application is created in a file with an extension of .apk, which is compressed in zip format. As shown in FIG. 2, the Android application includes seven areas. Functions of each area are described as below.

‘AndroidManifest.xml’ contains information required for running the Android application in a binary XML file form. The information may include the package name, the application name, version information, access permissions, and the like.

‘META-INF’ area is a directory in which electronic signature information (APK signing) of the application is stored.

‘assets’ area is a direction in which a file or data used in the relevant application is stored.

‘resources.arsc’ area contains text or multi-language text information used in the application.

‘lib’ area is a directory in which third parties or external libraries used in the application are stored.

‘classes.dex˜classesN.dex’ area contains executable files of the application. In the Android application package, the classes.dex˜classesN.dex files are generated by compiling source code of the application into a dex file which is executable on a Dalvic virtual machine of Google. In this case, when the total number of methods referenced within the corresponding source code is less than or equal to 65,536, only the classe.dex file is created. When the total number of methods exceeds 65,536, a plurality of dex files, such as classes2.dex, classes3.dex, . . . , classesN.dex, and so on, are sequentially created according to the number of methods referenced (where, N is a natural number greater than or equal to 2).

‘res’ area is a directory in which content, such as images, pictures, or the like), an icon file, and the like are stored.

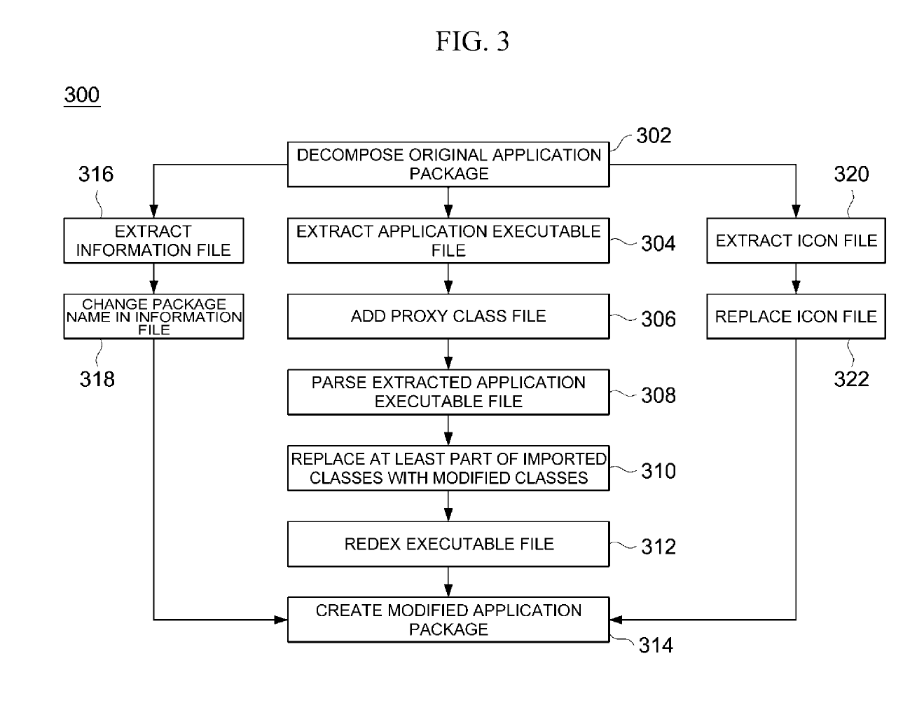

FIG. 3 is a flowchart for describing a method 300 of converting an application according to one embodiment of the present disclosure. The method shown in FIG. 3 may be performed by, for example, a computing device 12 which includes one or more processors and a memory storing one or more programs executed by the one or more processors. In the illustrated flowchart, the method is described as being divided into a plurality of operations. However, it should be noted that at least some of the operations may be performed in different order or may be combined into fewer operations or further divided into more operations. In addition, some of the operations may be omitted, or one or more extra operations, which are not illustrated, may be added and performed.

In operation 302, the computing device 12 decomposes an original application package. For example, in the case in which the original application package is an APK file, the computing device 12 may decompose the APK file by decompressing the original application package and obtain physical directories and files as described in FIG. 2 from the APK file.

In operation 304, the computing device 12 extracts an application executable file from the decomposed original application package. For example, in the case in which the original application package is an APK file, the extracted application executable file may be a file in the format of classes.dex. In this case, if a plurality of dex files are present in the application package, the computing device may extract a plurality of application executable files in the format of classes.dex to classesN.dex (where N is a natural number greater than or equal to 2).

In operation 306, the computing device 12 adds a proxy class file to the decomposed original application package.

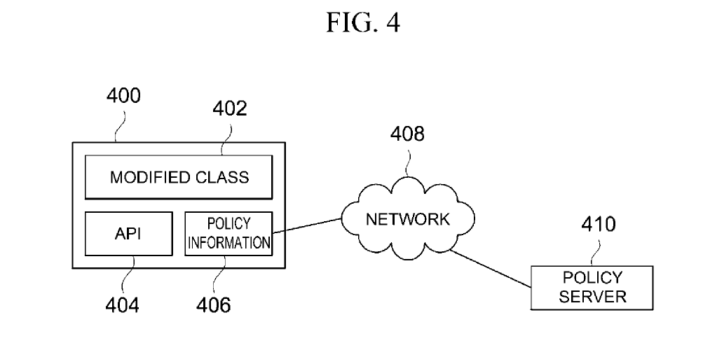

FIG. 4 is a block diagram for describing a proxy class file 400 according to one embodiment of the present disclosure. The proxy class file 400 in accordance with one embodiment of the present disclosure is a program executable code including an additional function to be added to the application and is created in the same format as the application executable file. For example, in the case in which the application executable file is in the format of classes.dex or classesN.dex, the proxy class file 400 is also created in the form of a dex file. The computing device 12 may add the proxy class file 400 at the same position as that of the application executable file.

As shown in FIG. 4, the proxy class file 400 according to one embodiment of the present disclosure may contain a modified class 402, an application programming interface (API) 404, and policy information 406. The modified class 402 is a class for executing the additional function to be added to the application.

The modified class 402 may be configured to replace one or more classes imported in the application to be modified or one or more super classes imported in the application to be modified. For example, the modified class 402 may replace a class related to a function of writing data to the computing device 12, thereby enabling the application to store data in preset secure storage rather than storing the data in an application directory. In addition, in another example, the modified class 402 may replace a class related to a function of controlling a camera of the computing device 12. In this case, the modified class 402 may detect an access of the application to a camera function, identify a current location of the computing device 12, and allow the access to the camera function only when the computing device 12 is not located within a predetermined security zone (such as with a particular building). The proxy class file 400 in accordance with one embodiment of the present disclosure may include one or more of such modified classes 402.

The API 404 is an interface for controlling a function required to execute the one or more modified classes 402. In addition, the policy information 406 is information referenced by the API 404. For example, in the case in which the API 404 performs a function related to security of the computing device 12 or a user of the computing device 12, the policy information 406 may be security policy information required for performing the above-described security function. As shown in FIG. 4, the policy information 406 may be received and stored from a remote policy server 410 through a network, and the API 404 may include a program executable code to receive and update the policy information 406 from the policy server 410.

Meanwhile, in operation 306, the computing device 12 may change a file name of the proxy class file by referring to file names of the application executable files and filename creation rules of the application executable files. In order for the modified classes included in the proxy class file to be referenced within the existing executable file, information of the proxy class file added in the Android operating system (OS) must be read. For example, in the case of the Android OS a runtime environment, called ART, is used. ART recognizes a plurality of Dalvik Executable (DEX) files in the format of classesN.dex from an APK file and compile the recognized files into a single .oat file so that an Android device can execute the files. To this end, the computing device 12 appropriately changes the file name of the added proxy class file to recognize the proxy class file added in the OS so that the added proxy class file can be read together with a previous application executable file. The file name of the application is executable file included in the original application package may be identified by such a method as APK scan or the like.

In the case of the Android OS, as described above, application executable files are created according to a rule, such as classes.dex, classes2.dex, classes3.dex, . . . , and classesN.dex (where N is a natural number greater than or equal to 2). Thus, if there is only one classes.dex file which is the existing application executable file, the file name of the proxy class file to be added may be changed to classes2.dex. In addition, classes.dex to classesN.dex files exist as the application executable files, the file name of the proxy class file to be added becomes classes(N+1).dex.

Referring back to FIG. 3, in operation 308, the computing device parses each of the extracted application executable files. For example, in the case in which the application executable files are in the format of classes.dex to classesN.dex, the computing device 12 references a file format of the DEX file to parse each file. The format of the DEX file is disclosed and provided by Google, and by parsing the DEX file, it is possible to identify classes, a method structure, and the like of the corresponding application.

In operation 310, the computing device 12 replaces at least a part of classes imported in the parsed application executable file with the modified classes 402 in the proxy class file 400. For example, it is assumed that the parsed application executable file imports the following classes.

import android.app.Activity;
import android.os.Bundle;
import android.widget.TextView;
. . .

The computing device 12 may replace android.app.Activity class and import android.widget.TextView class among the above classes with the modified classes 402, android.app.wrapped.Activity and android.widget.wrapped.TextView, respectively. This may be represented by program code as shown below.

import android.app.wrapped.Activity;
import android.os.Bundle;
import android.widget.wrapped.TextView;
. . .

As such, when at least a part of classes imported in the application executable file are replaced with the modified classes 402 in the proxy class file 400, it is possible to minimize the modification of code of the application executable file and effectively add a desired additional function to the application. The above operations 308 and 310 are performed for each of the executed application executable files.

Then, in operation 312, the computing 12 re-creates the application executable file modified through operations 308 and 310. Specifically, the computing device 12 may re-create the application executable file by redexing the classes.dex to classesN.dex files which are application executable files constructed by reflecting the changes.

In operation 314, the computing device 12 creates a modified application package. For example, in the case in which the original application package is an APK file, the computing device 12 replaces the existing application executable files (classes.dex to classesN.dex files) with the new application executable files (classes.dex to classes(N+1).dex files) including the DEX file and the proxy class file that are re-created in operation 312 and re-compresses the files and directories constituting the APK file to create the modified application package. The created modified application package may be signed using a preset signing key.

In the embodiments of the present disclosure, the additional function to be added to the application is not inserted into the application executable file of the original application, but added to the application executable file in the form of a separate file (proxy class file). In addition, the existing application executable files (classes.dex to classesN.dex) modify at least part of previously referenced class information, thereby allowing the additional function included in the proxy class file to be performed. With this configuration, it is possible to add the additional function to the application while still enabling the existing application executable file to avoid the 64K reference limit.

Meanwhile, the method 300 of converting an application in accordance with one embodiment of the present disclosure may further include an operation of changing a package name and an icon of the original application package. The changing of the package name and the icon of the original application package may be performed after operation 302, and may be performed concurrently with the above-described operations 304 to 312, or performed prior to or after operations 304 to 312.

First, the operation of changing the package name of the original application package will be described below.

In operation 316, the computing device 12 extracts an information file related to the execution of the original application package from the original application package decomposed in operation 302. For example, in the case where the original application package is an APK file, the information file may be an AndroidManifest.xml file.

In operation 318, the computing device 12 changes the package name of the original application package in the information file. For example, it is assumed that the application package name in the information file is stated as below.

package com.abc.emm.main;

In this case, the computing device 12 may change the package name, com.abc.emm.main, to com.abc.wrapped.emm.main. This may be represented by program code as shown below.

package com.abc.wrapped.emm.main;

In a general computing system, packages with the same package name are not redundantly installed. Therefore, when a package name of a modified application is changed as in the embodiment of the present disclosure, it is possible to simultaneously use a non-modified application and the modified application in one device. For example, in the case of the same e-mail applications, a non-modified, original application may be used for personal use and a modified application may be used for business use.

Then, the operation of changing the icon of the original application package will be described below.

In operation 320, the computing device 12 extracts an icon file of the original application package from the original application package decomposed in operation 302. For example, in the case where the original application package is an APK file, the icon file may be stored in res directory.

In operation 322, the computing device 12 replaces the icon file with an icon file for the modified application. In this case, the modified application file may be a file in which a visual indicator allowing for identification of the modified application is added to the extracted icon file.

When the icon of the modified application is changed as the embodiment of the present disclosure, a user is able to visually distinguish each application in an environment in which the non-modified application and the modified application are simultaneously installed.

The information file with the package name modified through the above operations and the replaced icon are included in the application package re-created in operation 314.

According to the embodiments of the present disclosure, the original application can be effectively modified to a security-enhanced application for EMM purposes while minimizing source code modification of the application.

In addition, according to the embodiments of the present disclosure, since a reference limit error, which may occur in modification of an application, can be effectively avoided, it is possible to apply the application modification to a large scale application.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method performed by a computing device including one or more processors and a memory in which one or more programs executed by the one or more processors are stored, the method comprising:
decomposing an original application package;
extracting one or more application executable files from the decomposed original application package;
adding a proxy class file comprising one or more modified classes to the decomposed original application package;
replacing one or more classes among classes imported in the one or more application executable files with corresponding ones of the one or more modified classes; and
creating a modified application package comprising the application executable files in which the one or more classes are replaced with the corresponding ones of the one or more modified classes.

2. The method of claim 1, wherein the proxy class file further comprises:
one or more application programming interfaces (APIs) used in execution of the one or more modified classes; and
one or more pieces of policy information referenced in the one or more APIs.

3. The method of claim 2, wherein each of the one or more APIs comprises program executable code for receiving and updating the one or more pieces of policy information from a preset remote server.

4. The method of claim 1, wherein the adding of the proxy class file comprises changing a file name of the proxy class file by referring to file names of the one or more application executable files and filename creation rules of the one or more application executable files.

5. The method of claim 1, further comprising after decomposing the original application package:
extracting an information file related to execution of the original application package from the decomposed original application package; and
changing a package name of the original application package in the information file.

6. The method of claim 1, further comprising, after decomposing the original application package:
extracting an icon file of the original application package from the decomposed original application package; and
replacing the icon file with a substitute icon file.

7. A computing device comprising:
a memory configured to store one or more programs; and
one or more processors configured to execute the one or more programs to:
decompose an original application package;
extract one or more application executable files from the decomposed original application package;
add a proxy class file comprising one or more modified classes to the decomposed original application package;
replace one or more classes among classes imported in the one or more application executable files with corresponding ones of the one or more modified classes; and
create a modified application package comprising the application executable files in which the one or more classes are replaced with the corresponding ones of the one or more modified classes.

8. The computing device of claim 7, wherein the proxy class file comprises:
one or more application programming interfaces (APIs) used in execution of the one or more modified classes; and
one or more pieces of policy information referenced in the one or more APIs.

9. The computing device of claim 8, wherein each of the one or more APIs comprises program executable code for receiving and updating the one or more pieces of policy information from a preset remote server.

10. The computing device of claim 7, wherein the adding the proxy class file comprises changing a file name of the proxy class file by referring to file names of the one or more application executable files and filename creation rules of the one or more application executable files.

11. The computing device of claim 7, wherein the one or more processors are further configured to execute the one or more programs to, after the decomposing the original application package:
extract information file related to execution of the original application file from the decomposed original application package; and
change a package name of the original application package in the information file.

12. The computing device of claim 7, wherein the one or more processors are further configured to execute the one or more programs to, after the decomposing the original application package:
extract an icon file of the original application package from the decomposed original application package; and
replace the icon file with a substitute icon file.

13. A non-transitory computer readable recording medium having embodied thereon one or more programs, which when executed by one or more processors of a computing device, causes the computing device to execute a method, the method including:
decomposing an original application package;
extracting one or more application executable files from the decomposed original application package;
adding a proxy class file comprising one or more modified classes to the decomposed original application package;
replacing one or more classes among classes imported in the one or more application executable files with corresponding ones of the one or more modified classes; and
creating a modified application package comprising the application executable files in which the one or more classes are replaced with the corresponding ones of the one or more modified classes.
